(19) United States
(12) Patent Application Publication
(10) Pub. No.: US 2008/0225552 A1
(43) Pub. Date: Sep. 18, 2008

(54) Illuminated Decal

(76) Inventor: Jonathan Paul Capriola, Sarasota, FL (US)

Correspondence Address: QUICKPATENTS, INC., 32861 CALLE PERFECTO, SUITE A, SAN JUAN CAPISTRANO, CA, 92675, US

(21) Appl. No.: 11/685,178

(22) Filed: Mar. 12, 2007

(51) Int. Cl. F21V 5/00

(52) U.S. Cl. 362/559; 362/555; 362/565

(57) ABSTRACT

An illuminated patch for fixing to apparel, headwear, or the like, is disclosed. The patch comprises a substantially flat decal that has at least one portion that is non-opaque, a front side and a back side. The back side of the decal is fixed to a front side of a substantially flat light-conducting diffuser that also includes a front side. A light conducting element is further included that has at least one end through which light may be introduced. A backing plate is included that has a front side, a back side, and a trough formed on the front side thereof for accommodating the light conducting element therein. The front side of the backing plate is fixed to the back side of the diffuser with the light conducting element captured therebetween. A light source is included for emitting light into the at least one end of the light conducting element. In use, light is emitted along the light conducting element, through the diffuser, and through the at least one non-opaque portion of the decal to illuminate the patch.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to illumination devices, and more particularly to an illuminated patch for application to clothing or other items.

### DISCUSSION OF RELATED ART

Illuminated patch assemblies for attaching to clothing, headgear such as hats, and the like are known in the prior art. Such illuminated patches are typically used for illuminating a logo or other message for either advertising, display of sports teams, political candidates, or the like.

Frequently with such devices, however, the logo is unevenly lit due to the structure of the device. For example, U.S. Pat. No. 4,667,274 to Daniel on May 19, 1987 teaches such a device. The structure disclosed shows a light source illuminating a front decal, and such structure results in a “hot spot” directly between the viewer and the light source on the decal. Such a structure further results in a thicker patch assembly since the light source needs to be placed further back behind the decal in order to illuminate the edges of the decal. Even with such a deep structure, however, the decal remains unevenly lit.

Similarly, U.S. Pat. No. 5,845,987 to Painter on Dec. 8, 1998, teaches an illuminated hat accessory that includes an LED bar (FIG. 14; Col. 9, lines 6-14). Such an LED light bar, however, and the other embodiments disclosed in the -987 patent, suffer the same drawbacks of uneven lighting. U.S. Pat. No. 7,131,745 to Sibbett on Nov. 7, 2006; and U.S. Pat. No. 6,116,745 to Yei on Sep. 12, 2000 suffer similar drawbacks. Moreover, such devices are rigid, relatively thick, and inflexible.

U.S. Pat. No. 5,111,366 to Rife et al. on May 5, 1992, teaches an illuminated hat indicia wherein the indicia is illuminated from the edge thereof Such an arrangement also results in uneven illumination of the indicia, the edges of the indicia being more brightly illuminated than the center section thereof.

In addition to being relatively thick, and therefore more difficult to integrate into a garment comfortably, prior art devices are inflexible, inefficient, and not easily adapted to different shapes or sizes. Therefore, there is a need for a relatively thin and somewhat flexible illuminated patch for fixing to a garment, hat, or the like comfortably. Such a needed invention would provide bright, even lighting of an indicia on the patch. Further, such a needed device would be quickly and inexpensively manufactured with a custom indicia or logo, of various shapes or sizes, and would be durably made with solid-state components for extended use. The present invention accomplishes these objectives.

### SUMMARY OF THE INVENTION

The present device is an illuminated patch for fixing to apparel, headwear, or the like. The patch comprises a substantially flat decal that has at least one portion that is non-opaque, a front side and a back side. A substantially flat light-conducting diffuser, such as a translucent sheet of vellum or the like, has a front side and a back side. The back side of the decal is fixed to the front side of the diffuser.

A light conducting element is further included that has at least one end through which light may be introduced. The light conducing element may be formed into a shape that evenly illuminates the back side of the diffuser. A backing plate is included that has a front side, a back side, and a trough formed on the front side thereof for accommodating the light conducting element therein. The front side of the backing plate is fixed to the back side of the diffuser with the light conducting element captured therebetween.

A light source is included for emitting light into the at least one end of the light conducting element. Such a light source is preferably at least one LED electrically connected to at least one battery through at least one switch, all preferably fixed to the back side of the backing plate.

In use, light is emitted along the light conducting element, through the diffuser, and through the at least one non-opaque portion of the decal to illuminate the patch.

The present invention is a relatively thin, somewhat flexible illuminated patch for fixing to a garment, hat, or the like. The present device provides bright, even lighting of an indicia on the patch is able to be quickly and inexpensively manufactured with a custom indicia or logo of various shapes or sizes. The present invention is durably made with solid-state components for extended, reliable use. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an exploded perspective view of the invention, illustrating a patch of the invention comprising a decal, a diffuser, a light conducting element, a backing plate, and at least one light source;

FIG. 2 is a cross-sectional view of the invention, taken generally along lines 2-2 of FIG. 6;

FIG. 3 is a partial exploded perspective view of an alternate embodiment of the invention, illustrated without the diffuser or light source;

FIG. 4 is a partial exploded perspective view of another alternate embodiment of the invention, illustrating the decal and the backing plate;

FIG. 5 is a partial exploded perspective side view of the other alternate embodiment of the invention, illustrating the decal and the backing plate; and

FIG. 6 is a perspective view of the invention, illustrating the patch as assembled.

### DETAILED DESCRIPTION OF THE PREFERRED EMBODIMENT

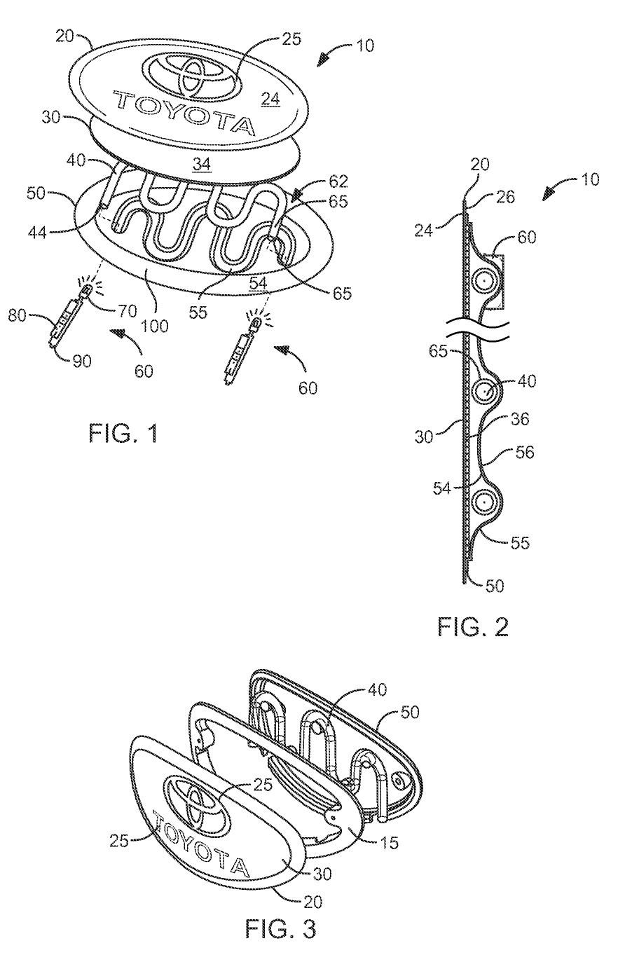

FIGS. 1 and 2 illustrate an illuminated patch 10 for fixing to apparel, headwear, or the like (not shown). The patch 10 comprises a substantially flat decal 20 that has at least one portion 25 that is non-opaque, a front side 24 and a back side 26. The decal 20 is preferably formed from a polyurethane material, but can also be made from vinyl or other suitably non-opaque and printable material.

A substantially flat light-conducting diffuser 30, such as a translucent sheet of vellum or the like, is further included. The diffuser 30 has a front side 34 and a back side 36. The back side 26 of the decal 20 is fixed to the front side 34 of the diffuser 30.

A light conducting element 40 is further included, and is made from a rigid or partially-rigid light-conducting fiber-optic light transmitting rod 62 made of plastic or other suitable material used in fiber optic applications. The light conducting element 40 includes at least one end 44 through which light may be introduced. A portion of light is dispersed through a side wall 65 of the light conducting element 40, the side wall 65 being formed to intercept the portion of the light and disperse same therethrough. The light conducing element 40 may be formed into a back-and-forth switchback pattern, as shown in FIGS. 1 and 3, to evenly illuminate the back side 36 of the diffuser 30.

A backing plate 50 is included that has a front side 54, a back side 56, and a trough 55 formed on the front side 54 thereof for accommodating the light conducting element 40 therein. The front side 54 of the backing plate 50 is fixed to the back side 56 of the diffuser 30, preferably with adhesive 100, with the light conducting element 40 captured therebetween. Preferably the backing plate 50 is made from a vinyl material formed from a vacuum forming process. Alternately, the backing plate may be injection molded, as shown in FIG. 3. In such an alternate embodiment, the diffuser 30 is stretched across a diffuser frame 15, which is itself injection molded and formed to cooperate with the backing plate 50 to capture the light conducting element 40 therebetween.

A light source 60 is included for emitting light into the at least one end 44 of the light conducting element 40. Such a light source 60 is preferably at least one LED 70 electrically connected to at least one battery 80 through at least one switch 90, as illustrated in FIG. 1. An LED controller circuit (not shown) may be further included to produce flashing or other effects with the LEDs 70. The at least one LED 70, battery 80, and switch 90 are preferably fixed to the back side 56 of the backing plate 50. In one embodiment of the invention, the light source 60 is enclosed in an enclosure integrally formed with the backing plate 50 (not shown).

In use, light is emitted along the light conducting element 40, through the diffuser 30, and through the at least one non-opaque portion 25 of the decal 20 to illuminate the patch 10 (FIG. 6). The patch 10 may be applied to an article of clothing, a hat, or the like (not shown), as desired by those skilled in the art.

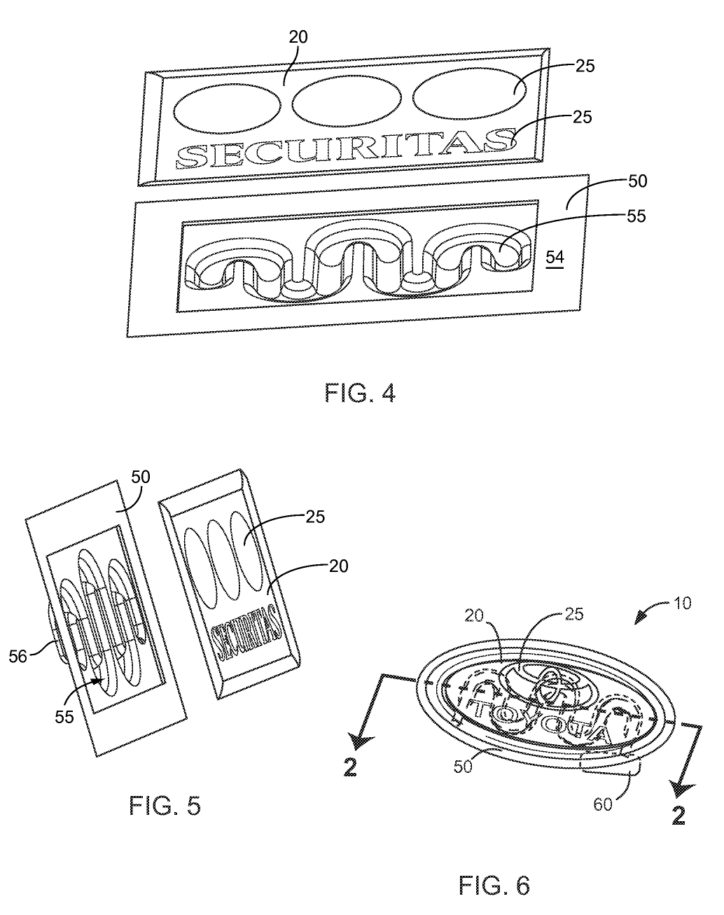

While a particular form of the invention has been illustrated and described, it will be apparent that various modifications can be made without departing from the spirit and scope of the invention. For example, the backing plate 50 may be ultrasonically welded to the diffuser 30 and decal 20. The shape of the decal 20, diffuser 30, and backing plate 50 may be oval (FIGS. 1 and 3), square (not shown), rectangular (FIGS. 4 and 5), circular (not shown), or any other suitable shape. The shape of the light conducting element 40 may be a switchback shape as shown in FIGS. 1 and 3, or any other suitable shape to create a desired distribution of light against the diffuser 30. Accordingly, it is not intended that the invention be limited, except as by the appended claims.

What is claimed is:

1. An illuminated patch comprising:
a substantially flat decal having at least one portion that is non-opaque, a front side, and a back side;
a substantially flat light-conducting diffuser having a front and a back side, the back side of the decal fixed to the front side thereof,
a light conducting element traversing the back side of the diffuser and having at least one end;
a backing plate having a front side, a back side, and a trough for accommodating the light conducting element therein, the front side of the back plate fixed to the back side of the diffuser, the light conducting element captured therebetween; and
a light source for emitting a light into the at least one end of the light conducting element;
whereby the light is emitted along the light conducting element, through the diffuser, and through the at least one non-opaque portion of the decal to illuminate the patch.

2. The illuminated patch of claim 1 wherein the decal is formed from a polyurethane material.

3. The illuminated patch of claim 1 wherein the diffuser is made of a vellum material.

4. The illuminated patch of claim 1 wherein the light conducting element is a fiber-optic rod, the rod dispersing a portion of light through a side wall thereof.

5. The illuminated patch of claim 1 wherein the backing plate is a vinyl material made from a vacuum forming process.

6. The illuminated patch of claim 1 wherein the light source is an LED electrically connected to a battery.

7. The illuminated patch of claim 6 further including a power switch electrically connected between the LED and the battery.

8. The illuminated patch of claim 6 wherein the LED and battery are fixed to the back side of the backing plate.

9. The illuminated patch of claim 1 wherein the light conducting element is bent back and forth across the back of the diffuser to substantially evenly illuminate the back side of the diffuser.

10. The illuminated patch of claim 1 wherein the front side of the backing plate is fixed to the back side of the diffuser with adhesive.

11. The illuminated patch of claim 1 wherein the back side of the decal is fixed to the front side of the diffuser with adhesive.

12. The illuminated patch of claim 6 wherein the light source is a pair of LEDs, each fixed to one of two ends of the light conducting element.
